(19) United States
(12) Patent Application Publication
(10) Pub. No.: US 2017/0333911 A1
(43) Pub. Date: Nov. 23, 2017

(54) DEVICE FOR GRANULATING SLUDGE

(71) Applicant: STELA Laxhuber GmbH, Massing (DE)

(72) Inventors: Thomas Christian Laxhuber, Massing (DE); Tobias Latein, Erlbach (DE)

(21) Appl. No.: 15/526,408

(22) PCT Filed: Nov. 14, 2014
(86) PCT No.: PCT/DE2014/100401

§ 371 Date: May 12, 2017

(51) Int. Cl. B02C 18/06; B02C 18/00; C02F 11/12

(52) U.S. Cl. CPC B02C 18/062; C02F 11/12; B02C 18/0092; C02F 2303/26

(57) ABSTRACT

A device for granulating sludge has a hollow-cylindrical die into which sludge to be granulated is to be injected and in which a stripper with at least one knife is rotatingly arranged. A knife holder holds at least one knife radially movably on the rotating stripper.

### BACKGROUND

### 1. Field of the Invention

The invention relates to a device for granulating sludge having a hollow-cylindrical die into which sludge to be granulated is to be injected and in which a stripper with at least one knife is rotatingly arranged. The invention further relates to a method for operating a device for granulating sludge, in which method sludge to be granulated is injected into a hollow-cylindrical die and a stripper is rotated in the die.

The at least one knife can also be referred to as a scraper or stripping disc, which, driven by the stripper, is moved or pushed over the inner surface of the hollow-cylindrical die and thereby, in combination with applied pressure, forces the sludge to be granulated from the inside to the outside through passage openings which are formed in the die.

### 2. Description of the Related Art

A device and a method of the generic type are known from DE 202 02 626 U1 originating from the applicant. With the device described there, mechanically pre-dewatered sludge is if necessary processed into a free-flowing granulate, in order to be able to dry this granulate subsequently in a rapid as well as energy- and cost-effective manner. A granulation of the sludge before drying brings about an increase in efficiency during the subsequent drying, because the granulate has a relatively large surface to volume ratio. Thus, evaporation of water from the granulate is simplified and the residence time in the subsequent drying is considerably reduced. In addition, a dried granulate is easier to handle, in particular in respect of the packaging and/or the metering as fuel.

The object on which the invention is based is to provide a device and a method for granulating sludge which, compared with conventional devices and methods, are even more efficient and productive. It is particularly relevant that the sludge to be granulated may have greatly varying compositions and consistencies and also contain foreign substances, such as hair.

### SUMMARY

This object is achieved according to the invention by a device for granulating sludge having a hollow-cylindrical die into which sludge to be granulated is to be injected and in which a stripper with at least one knife is rotatingly arranged. According to the invention, the at least one knife is held substantially radially movably on the rotating stripper by means of a knife holder. The knife held radially movably in the stripper according to the invention can, when sweeping over the die and its outlet openings, evade the sludge material which may accumulate at the outlet openings, as investigations according to the invention have shown. Owing to the fact that the knife according to the invention surmounts or sweeps over this banked-up sludge material, it does not block the rotation of the associated stripper and thus ensures the continuous operation thereof. The knife according to the invention is preferably arranged substantially radially directed, which means that its pawl or disc plane extends substantially radially.

The knife according to the invention mounted evasively in its height position is moved particularly advantageously within the die in alternating circumferential direction, and therefore the associated stripper rotates alternatingly first clockwise and then anticlockwise. Thus, the aforementioned outlet openings in the die are swept over first clockwise and then subsequently anticlockwise. As a result of this, by the stripper according to the invention, with its knives, residues or banked-up sludge material which has accumulated on one side of the respective outlet opening is moved towards the other side into the centre of the outlet opening and then out of the die through the outlet opening.

In the device according to the invention for granulating sludge, the at least one knife held substantially radially movably on the knife holder may be freely displaceable under its own weight. Such a design is particularly simple and therefore cost-effective and operationally reliable, because then no additional apparatus is required for the pressing of the knife according to the invention onto the inner surface of the die. Alternatively, the knife according to the invention can also be pressed against the inner surface of the hollow-cylindrical die by means of an elastic element, such as a helical spring or a leaf spring.

The freely displaceable knife may be held on the knife holder in the circumferential direction of the hollow-cylindrical die with a clearance of between 1% to 4% of the inside diameter of the hollow-cylindrical die, preferably between 2% and 3% of the inside diameter of the hollow-cylindrical die. Such a clearance or free space between knife holder and knife allows on the one hand a sufficiently precise guidance of the knife and on the other hand a movement space for the knife which is of such a size that jamming or clogging during the operation of the device according to the invention is safely avoided.

A plurality of individual knives may be arranged successively on the knife holder in the axial direction of the hollow-cylindrical die. The plural individual knives allow a pointwise evasion or yielding at individual portions of the axial extent of the hollow-cylindrical die. At other regions, however, the knives there remain placed against the die, so that they work there accordingly without residue.

The plurality of individual knives may be offset in the circumferential direction of the hollow-cylindrical die. With the offset, in the circumferential direction, of the knives arranged axially one behind the other, the stability or rigidity of the associated stripper can be increased. The individual knives do not all sweep over associated passage openings simultaneously, if these openings are advantageously arranged in an axial row, in particular at the downward-facing region of the hollow-cylindrical die.

The at least one knife that is held substantially radially movably, may have a knife height that is between 95% to 98% of the inside diameter of the hollow-cylindrical die, preferably between 96% and 97% of the inside diameter of the hollow-cylindrical die. With such a design the knives according to the invention can yield, but at the same time circulate substantially the entire sludge material in the hollow-cylindrical die upon rotation of the associated stripper.

The knife holder may be formed by a tube extending axially in the hollow-cylindrical die. The tube of this kind is cost-effective to produce and can at the same time transmit a high torsional moment, with the result that it is then possible to drive the stripper, rotating according to the invention, at only one of its axial ends.

The tube may have at least one through opening that extends transverse to the alignment of the at least one substantially radially movably held knife. The at least one through opening is thus situated on the tube in a portion that is comparatively far from the holder of the knives. This is advantageous both with regard to a low-resistance flow through the tube and with regard to a high rigidity of the tube. In order to further improve the flow through the stripper according to the invention, it is furthermore advantageous also to design the at least one knife with through openings in its disc plane.

The at least one knife held substantially radially movably may be held at its two opposite end regions by the knife holder. The knife is thus held, in relation to the hollow-cylindrical die, therefore at diametrically opposite end regions or driven with respect to its rotational movement. With this support, a high torque can be transmitted to the knife without the risk of tilting or even deformation of the knife.

The at least one substantially radially movably held knife may be V-shaped in cross-section at least at one end facing the die. Owing to the V-shape the knife advantageously slides over the die and also over banked-up material therein. At the same time, the V-shape forms a kind of cutting edge, by means of which banked-up material can be pushed away particularly strongly.

The invention further is directed to a method for operating a device for granulating sludge, in particular of the above-mentioned kind, in which method sludge to be granulated is injected into a hollow-cylindrical die, a stripper is rotated in the die, and the stripper is rotated alternatingly with respect to its direction of rotation. Thus, as explained above, the die is swept over first clockwise and then subsequently swept over counterclockwise. As a result of this, by the stripping according to the invention, residues or banked-up sludge material can be pushed away in both circumferential directions. An accumulation of material on only one side of associated outlet openings of the die is avoided reliably.

### BRIEF DESCRIPTION OF DRAWINGS

FIG. 1 is a perspective view of an exemplary embodiment of a device for granulating sludge according to the invention.

FIG. 2 is a section taken along line II-II in FIG. 1.

### DETAILED DESCRIPTION

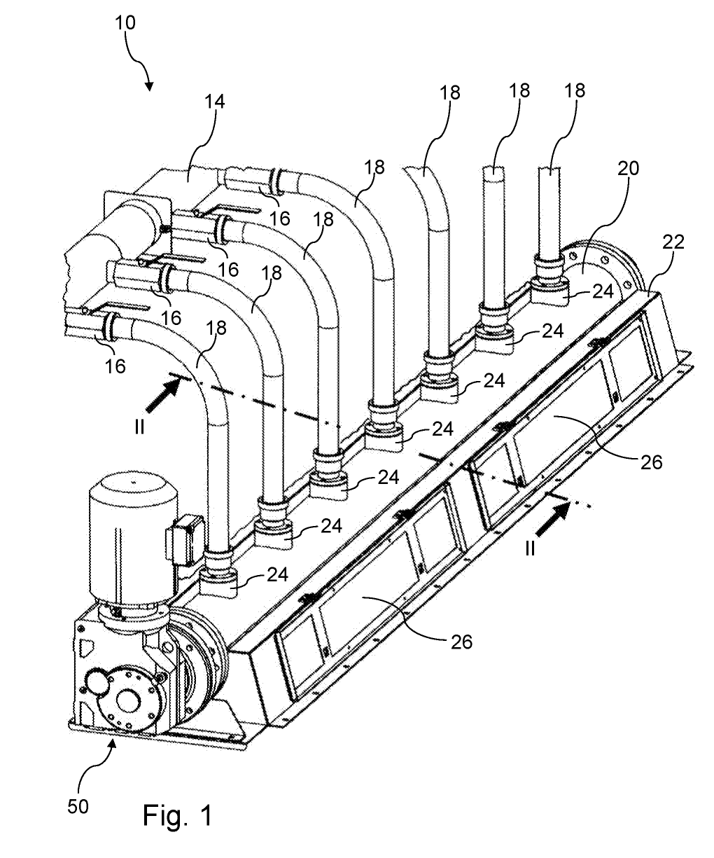

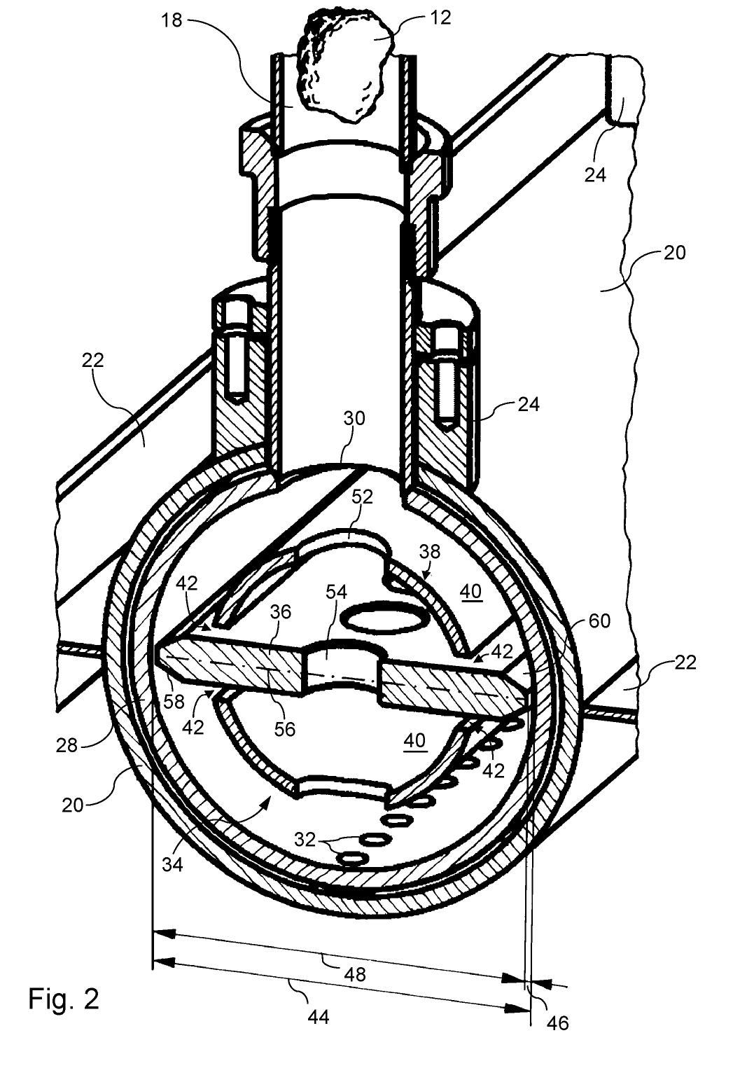

In FIGS. 1 and 2 there is illustrated a device 10 for granulating sludge 12, in which the sludge 12 is distributed by means of a main supply line 14, by a plurality of valves 16 connected thereto, into respectively associated individual supply lines 18. The individual supply lines 18 respectively lead to a place on the longitudinal extent of a supporting tube 20 at which they are fluid-conductingly coupled there by means of respectively one line connection 24. The supporting tube 20 is mounted stationarily by means of a tube holder 22. In the tube holder 22 there are embedded, inter alia, viewing windows 26 that allow an operator of the device 10 to look under the supporting tube 20.

Situated in the supporting tube 20 is a hollow-cylindrical die 28, the outside diameter of which is only slightly smaller than the inside diameter of the supporting tube 20. The hollow-cylindrical die 28 extends substantially over the entire length of the supporting tube 20 and has, in its upper portion in relation to FIG. 2, respective inlet openings 30 through which sludge 12 to be granulated can then be led from the individual supply lines 18 and the associated line connections 24 into the interior of the hollow-cylindrical die 28. Furthermore, at the lower portion of the die 28 in relation to FIG. 2, there is situated in the longitudinal direction thereof a row of outlet openings 32. The sludge 12 can then be led out of the die 28 again through these outlet openings 32, congruent openings also being situated in the supporting tube 20, although they are not shown in the present case.

In the interior of the hollow-cylindrical die 28 there is situated coaxially thereto a stripper 34 which rotates in the die 28 and thereby sweeps over the outlet openings 32 in such a manner that the sludge 12 forced out through these outlet openings 32 is portioned or granulated.

For this purpose, the stripper 34 is provided with a plurality of plate-shaped scrapers or knives 36 that are held, successively in the longitudinal or axial direction of the stripper 34 and offset relative to one another in the circumferential direction, on a knife holder 38 so as to be movable substantially in the radial direction. The knife holder 38 is formed by a tube 40 that extends likewise coaxially relative to the hollow-cylindrical die 28 and has an outside diameter of about ½ to ⅔ of the inside diameter 44 of the die 28. Formed in the tube 40 are respectively mutually diametrically opposite longitudinal slots 42, in which respectively one of the knives 36 is held with a clearance 46 in the circumferential direction of about ½ of the knife thickness or in the present case of between 2% and 3% of the inside diameter of the hollow-cylindrical die 28. The respective knife 36 is otherwise freely movable in the two associated longitudinal slots 42 of its knife holder 38 and is thus forced downwards in relation to FIG. 2 by its own weight and in the direction of the outlet openings 32 during the rotation of the stripper 34. The knives 36, when sweeping over the associated outlet openings 32, therefore press radially downwards due to their own weight. The knives 36 accordingly lie either directly on the inner surface of the hollow-cylindrical die 28 at the lower region thereof or they sweep over any sludge material which may have accumulated there at the edges of the outlet openings 32. The individual knives 36 have respectively a knife height 48 that is less than the inside diameter 44 of the hollow-cylindrical die 28, namely in the present case between 96% and 97% of the inside diameter 44 of the hollow-cylindrical die 28. The knives 36 therefore have, with respect to the inside diameter 44 of the hollow-cylindrical die 28, inside the latter likewise some play or freedom of movement, in order to be able to surmount sludge material that has banked up to a certain extent and not block the rotational movement of the stripper 34.

For the rotational or rotary movement of the stripper 34, a drive 50 is provided at one end of the supporting tube 20, by means of which drive the stripper 34 can be rotated alternatingly with respect to its direction of rotation. The stripper 34 can therefore be rotated both clockwise and anticlockwise. With this alternating rotation, it is possible to change the stripping direction of the knives 36 over the outlet openings 32. The outlet openings 32 are therefore, in relation to the sectional view according to FIG. 2, swept over first clockwise and then anticlockwise. In this way it is possible for sludge residues that have accumulated on one side of one of the outlet openings 32 to be removed on the return sweep of the associated knife 36.

It should further be noted that the tube 40 as well as the knives 36 have through openings 52 and 54, respectively. The through openings 52 pass through the wall of the tube 40 in its centre transversely to the alignment of the respectively adjacent knife 36. The through openings 54 also pass through the respective knife 36 centrally transversely to its disc plane 56.

The knives 36, held in such a way with play at their opposite end regions 58 and 60 by means of the tube 40 and its longitudinal slots 42, are moreover of V-shaped form in cross-section at these end regions 58 and 60, the two flanks or legs of the V-shape each facing the inner surface of the hollow-cylindrical die 28.

In conclusion, it should be noted that all the features that have been mentioned in the application documents and in particular in the dependent claims, despite their formal dependence on one or more specific claims, should also be accorded independent protection individually or in an any arbitrary combination.

### LIST OF REFERENCE NUMERALS

10 device
12 sludge
14 main supply line
16 valve
18 individual supply line
20 supporting tube
22 tube holder
24 line connection
26 viewing window
28 die
30 inlet opening in the die
32 outlet opening in the die
34 stripper
36 knife
38 knife holder
40 tube
42 longitudinal slot
44 inside diameter
46 clearance
48 knife height
50 drive
52 through opening of the tube
54 through opening of the knife
56 disc plane of the knife
58 end region
60 end region

1. A device (10) for granulating sludge (12) comprising a hollow-cylindrical die (28) into which sludge (12) to be granulated is to be injected and in which a stripper (34) with at least one knife (36) is rotatingly arranged, wherein the at least one knife (36) is held substantially radially movably on the rotating stripper (34) by a knife holder (38).

2. The device for granulating sludge of claim 1,
wherein the at least one knife (36) held substantially radially movably on the knife holder (38) is freely displaceable under its own weight.

3. The device for granulating sludge of claim 2,
wherein the freely displaceable knife (36) is held on the knife holder (38) in the circumferential direction of the hollow-cylindrical die (28) with a clearance (46) of between 1% to 4% of the inside diameter (44) of the hollow-cylindrical die (28).

4. The device for granulating sludge of claim 1,
wherein the knife holder (38) has a plurality of individual knives (36) arranged successively in the axial direction of the hollow-cylindrical die (28).

5. The device for granulating sludge of claim 4,
wherein the individual knives (36) are arranged offset in the circumferential direction of the hollow-cylindrical die (28).

6. The device for granulating sludge of claim 1,
wherein the at least one knife (36) held substantially radially movably has a knife height (48) that is between 95% to 98% of the inside diameter (44) of the hollow-cylindrical die (28).

7. The device for granulating sludge of claim 1,
wherein the knife holder (38) has a tube (40) extending axially in the hollow-cylindrical die (28).

8. The device for granulating sludge of claim 7,
wherein the tube (40) has at least one through opening (52) that extends transversely to the alignment of the at least one substantially radially movably held knife (36).

9. The device for granulating sludge of claim 1,
wherein the at least one knife (36) held substantially radially movably is held at its two opposite end regions (58, 60) by the knife holder (38).

10. A method for operating the device (10) for granulating sludge (12) of claim 1, wherein the sludge (12) to be granulated is injected into a hollow-cylindrical die (28) and a stripper (34) is rotated in the die (28),
comprising rotating the stripper (34) alternatingly with respect to its direction of rotation.
